(19) United States
(12) Patent Application Publication
(10) Pub. No.: US 2025/0209890 A1
(43) Pub. Date: Jun. 26, 2025

(54) Counter Tilting

(71) Applicant: DK Crown Holdings Inc., Boston, MA (US)

(72) Inventor: Robert Edward Barnes, St Albans (GB)

(73) Assignee: DK Crown Holdings Inc., Boston, MA (US)

(21) Appl. No.: 18/391,864

(22) Filed: Dec. 21, 2023

(51) Int. Cl. G07F 17/32

(52) U.S. Cl. CPC G07F 17/3288

(57) ABSTRACT

Devices, systems and methods for aligning pricing for a single game parlay (SGP) with a single bet are provided. A system includes a server processor instantiating a Counter Tilting Engine (CTE) which aligns the first SGP pricing with a single bet pricing. The server outputs to a user device, an adjusted first SGP betting line that is aligned with a current single bet pricing for the first activity for the event. The CTE aligns the first SGP pricing with the current single bet pricing by receiving an initial SGP pricing based on a counters, receiving an initial single bet pricing for the single bet line, determining if the initial single bet pricing and the initial SGP pricing are aligned, and when not aligned, contemporaneously adjusting the counters and generating an adjusted first SGP pricing until the adjusted first SGP pricing aligns with the current single bet pricing.

### TECHNICAL FIELD

The technology described herein generally relates to devices, systems, and processes for adjusting market pricing player for mainline handicap and over/under bets for sporting events where the bets are placed as a same game parlay bet.

### BACKGROUND

An online gaming system (“OGS”) commonly utilizes a combination of one or more gaming servers (herein, a “front-end system (FES)”—as further described below) that receive data feeds from one or more third party servers (herein, each a “back-end system (BES)”—as further described below), such as SWISH™ data provided by Swish Analytics of San Francisco, California, USA and Sportradar of St. Gallen, Switzerland. The FES commonly facilitates betting by bettors (herein, each being a “user”) on one or more “events,” including live events. The FES uses data provided by the BES. As used herein, an “event” is an occurrence of a future result with respect to which data currently exists, as provided by the BES, to create odds and prices for facilitating betting on the future result. For example, an event may be a basketball game with respect to which odds of team A prevailing over team B may be generated and pricing based on such odds specified such that a user may place a bet on a future result of the event, such as the winner, the final score, or other results from the basketball game.

An event may include multiple quantifiable sub-parts (herein, each an “activity”) with respect to which bets may be placed. For example, a basketball game may include activities such as points, assists, blocks, steals, turnovers and the like. The activities may be tabulated as the event occurs and an OGS will often allow a user to place bets based on various future potential event activities (e.g., the score at a particular point of time later in the basketball game). The later time may be within any given time period, such as within seconds, minutes, or otherwise.

Further, a FES may allow a user to place same game parlay (“SGP”) bets wherein bets are placed on multiple future activities occurring. For example, an SGP may include bets on total points scored and total assists in a given event. Today, data is provided by the BES which the FES uses to determine odds, pricing, and results for activities, SGPs, and other forms of bets.

Further, an event typically includes one or more “event entities” (herein, each a “player”) that participate in the event and/or an event activity. Non-limiting examples of players include a team, an individual participant on a team, a collection of participants on a team (e.g., an NFL defensive squad), a coach of a team, or otherwise. Event activities, such as scoring activities, may be attributed to one or more players. A player's activities may be further identified in a player props line (a “Props”). The BES may provide the Props. For example, a player's scoring activity may be identified as an over/under of a given point total in a Props. For a further example, a Props may identify a player scoring greater (over) or less (under) twenty points in a game. Bets may be placed in view of the odds, other users' bets, statistical results, and other data of the player so scoring over or under the given total.

The player's activities may be further attributed to various team categories that collectively contribute to the overall performance of a team of players for the given event. For example, player A may score a basket and thereby contribute points to a team's overall score, while player B provides an assist that results in the basket being scored. Collectively, player activities result in team activities.

Commonly, a FES will provide users with various team-based betting options and various SGP player betting options. For example, a team-based betting option may be generated based on a first team model while an SGP player betting option may be generated based on a second Props model. While both models may consider total points scored by a given player by quarter, overall, or otherwise (e.g., a scoring activity by a basketball team may occur by a first player or another player), and while data regarding team-based event activities and Props is commonly readily available, correlations, and systems and methods for generating such correlations, of an individual player's contributions to the team-based event activities are needed for pricing of SGPs, which may include real-time SGPs (“RSGPs”).

Further, to price a given betting option, grid tilting is commonly utilized for no SGP bets. Grid tilting commonly involves a manipulation of a pricing model output to align with market prices that are occurring post running of the one or more simulations which generated a given pricing model output. A new grid is generated based on the manipulations of the pricing model, and the new grid, for non-SGP bets, is used to price betting markets-which are commonly ensured to align with a mainline handicap betting line and with an over/under betting line for a given activity. Such a process however does not work for an SGP because correct score grids are not utilized and instead, counters generated based on one or more simulations for results of the given activity are utilized. This commonly results in a misalignment in prices for a given betting line placed as a single bet with the same betting line, when placed in an SGP.

Accordingly, devices, systems and processes are needed for aligning betting lines for a given bet that is placed as a single bet or a SGP bet.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of various implementations of the present disclosure is provided in the following written description and illustrated in the accompanying drawings.

Various implementations are described of devices, systems, and processes for aligning models outputs from models for a given betting line used in an SGP bet with a correct score grid utilized for the given betting line, when placed in a single bet.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more computer programs can be configured to perform particular operations or actions by virtue of including instructions that, when executed by a data processing apparatus, cause the apparatus to perform the actions.

For at least one implementation, an aligned single game parlay system may include a user device having a processor executing first non-transient computer instructions which instantiate a single game parlay (“SGP”) application. For at least one implementation, the SGP application may provide a SGP application user interface which facilitates selection, by a user of the user device, of an SGP bet including a first SGP betting line and a second SGP betting line for an event. For at least one implementation, the first SGP betting line may specify a first SGP pricing for a first activity for the event. For at least one implementation, the second SGP betting line may specify a second SGP pricing for a second activity for the event. For at least one implementation, the aligned single game parlay system may further include a front-end server having a front-end processor executing second non-transient computer instructions which instantiate a Counter Tilting Engine (CTE) which performs CTE operations. For at least one implementation the CTE operations may include aligning the first SGP pricing with a single bet pricing, for a single bet line for the first activity for the event. For at least one implementation, the front-end server may output to the SGP application, for presentation to the user, an adjusted first SGP betting line that is aligned with a current single bet pricing for the first activity for the event.

For at least one implementation of an aligned single game parlay system, the CTE may align the first SGP pricing with the current single bet pricing by further performing CTE operations that include receiving an initial SGP pricing for the first SGP betting line. The initial SGP pricing may be determined based on an initial set of counters. The CTE operations may further include receiving an initial single bet pricing for the single bet line and determining if the initial single bet pricing and the initial SGP pricing are aligned. When aligned, the CTE operations may include using the initial SGP pricing for the first SGP betting line. When not aligned, the CTE operations may include contemporaneously adjusting the initial set of counters to provide an adjusted set of counters and outputting the adjusted set of counters. For at least one implementation, based on the adjusted set of counters, the front-end server may iteratively generate one or more instances of an adjusted first SGP pricing until the adjusted first SGP pricing aligns with the current single bet pricing.

For at least one implementation of an aligned single game parlay system, the initial set of counters includes at least one thousand counters. For at least one implementation, a counter is an array that indicates whether a given participant in the first activity will produce a given result.

For at least one implementation of an aligned single game parlay system, the adjusting of the initial set of counters to provide the adjusted set of counters may further include duplicating at least one counter selected from the initial set of counters to provide a duplicated counter and adding the duplicated counter to the initial set of counters to produce the adjusted set of counters. For at least one implementation, the adjusted set of counters may include the initial set of counters plus the duplicated counter.

For at least one implementation of an aligned single game parlay system, the adjusting of the initial set of counters to provide the adjusted set of counters may further include deleting, a deleted counter, from the initial set of counters. For at least one implementation, the adjusted set of counters includes the initial set of counters less the deleted counter.

For at least one implementation of an aligned single game parlay system, the front-end processor may further execute third non-transient computer instructions which instantiate an Event Simulation Engine (ESE) which performs ESE operations including receiving the adjusted set of counters from the CTE, generating, based on the adjusted set of counters, adjusted simulations for the first activity, and outputting the adjusted simulations.

For at least one implementation of an aligned single game parlay system, the front-end processor may further execute fourth non-transient computer instructions which instantiate a Props Counter Engine (PCE) which performs PCE operations including receiving the adjusted simulations from the ESE, determining, based on the adjusted simulations, an adjusted first probability of a future result occurring for the first SGP betting line, determining, based on the adjusted simulations, an adjusted second probability of the future result not occurring for the first SGP betting line, and outputting the adjusted first probability and the adjusted second probability.

For at least one implementation of an aligned single game parlay system, the front-end processor may further execute fifth non-transient computer instructions which instantiate an SGP Pricing Engine (SPE) which performs SPE operations including associating an adjusted first pricing with the adjusted first probability, associating an adjusted second pricing with the adjusted second probability, and generating the adjusted first SGP betting line based on the adjusted first pricing and the adjusted second pricing. For at least one implementation, the CTE receives the adjusted first SGP betting line and determines whether the adjusted first SGP betting line aligns with the current single bet pricing. For at least one implementation, when the betting lines are not aligned, the front-end processor may iteratively repeat the CTE operations, ESE operations, PCE operations and SPE operations until a currently adjusted first SGP pricing and the current single bet pricing align.

For at least one implementation of an aligned single game parlay system, a back-end server may communicate, to the front-end server, betting data for the first activity for the event. The back-end server may further communicate the betting data to the front-end server on a real-time basis while the first activity occurs. The front-end server, based on the betting data, may update the current single bet pricing for the single bet line.

For at least one implementation of an aligned single game parlay system, the front-end server may further align the second SGP betting line with a second single bet line. The second single bet line may specify a current second single bet pricing for the second activity for the event. The front-end server may determine on a real-time basis and based on the betting data received, on a real-time basis, from the back-end server, an updated betting option for the SGP bet. The front-end server may communicate, on a real-time basis, the updated betting option for the SGP bet to the SGP application instantiated on the user device. The SGP application may present the updated betting option for the SGP bet as an updated SGP bet to the user in order to facilitate real-time selection by the user of the updated SGP bet during the event.

For at least one implementation of an aligned single game parlay system, the SGP bet may include a combination, identified by the user, of two or more betting activity options for the event.

For at least one implementation of the present disclosure, a process for aligning pricing, by a server, for a first Single Game Parlay (“SGP”) betting line with a single bet line, for a first activity for an event, by the server performing counter tilting operations that include receiving an initial SGP pricing for the first SGP betting line. The initial SGP pricing may be determined based on an initial set of counters. The counter tilting operations may further include receiving an initial single bet pricing for the single bet line and determining if the initial single bet pricing and the initial SGP pricing are aligned. When aligned, the counter tilting operations may include using the initial SGP pricing for the first SGP betting line. When not aligned, the counter tilting operations may include adjusting the initial set of counters to provide an adjusted set of counters and iteratively generating, based on the adjusted set of counters, one or more instances of an adjusted first SGP pricing until the adjusted first SGP pricing aligns with a current single bet pricing for the single bet line.

For at least one implementation of the process, the counter tilting operations may further include adjusting the initial set of counters to provide the adjusted set of counters by further performing at least one of counter duplication operations and counter deletion operations. The counter duplication operations may include duplicating at least one counter selected from the initial set of counters to provide a duplicated counter and adding the duplicated counter to the initial set of counters to provide, as the adjusted set of counters, the initial set of counters plus the duplicated counter. The counter deletion operations may include deleting at least one counter from the initial set of counter to provide, as the adjusted set of counters, the initial set of counters less the duplicated counter.

For at least one implementation the process may include generating, based on the adjusted set of counters, adjusted simulations for the first activity, determining, based on the adjusted simulations, an adjusted first probability of a future result occurring for the first SGP betting line, determining, based on the adjusted simulations, an adjusted second probability of the future result not occurring for the first SGP betting line, associating an adjusted first pricing with the adjusted first probability, associating an adjusted second pricing with the adjusted second probability, and generating the adjusted first SGP betting line based on the adjusted first pricing and the adjusted second pricing.

For at least one implementation, the process may include determining whether the adjusted first SGP betting line aligns with the current single bet pricing and, when not aligned, iteratively repeating the counter tilting operations until a currently adjusted first SGP pricing is aligned and the current single bet pricing.

For at least one implementation, a computer readable medium may store non-transient computer instructions which when executed by a processor in a server instruct the server to perform counter tilting operations including receiving an initial Single Game Parlay (SGP) pricing for a first SGP betting line for a first activity for an event. The initial SGP pricing may be determined based on an initial set of counters. The counter tilting operations may further include receiving an initial single game pricing for a single game betting line for the given activity for the event, and determining if the initial single bet pricing and the initial SGP pricing are aligned. When aligned, the counter tilting operations may include using the initial SGP pricing for the first SGP betting line. When not aligned, the counter tilting operation may include adjusting the initial set of counters to provide an adjusted set of counters and iteratively generating, based on the adjusted set of counters, one or more instances of an adjusted first SGP pricing until the adjusted first SGP pricing aligns with a current single bet pricing for the single bet line.

For at least one implementation of the computer readable medium, the counter tilting operations further include adjusting the initial set of counters to provide the adjusted set of counters by further performing at least one of counter duplication operations and counter deletion operations. The counter duplication operations may include duplicating at least one counter selected from the initial set of counters to provide a duplicated counter and adding the duplicated counter to the initial set of counters to provide, as the adjusted set of counters, the initial set of counters plus the duplicated counter. The counter deletion operations may include deleting at least one counter from the initial set of counter to provide, as the adjusted set of counters, the initial set of counters less the duplicated counter.

For at least one implementation of the computer readable medium, the counter-tilting operations may include generating, based on the adjusted set of counters, adjusted simulations for the first activity, determining, based on the adjusted simulations, an adjusted first probability of a future result occurring for the first SGP betting line, determining, based on the adjusted simulations, an adjusted second probability of the future result not occurring for the first SGP betting line, associating an adjusted first pricing with the adjusted first probability, associating an adjusted second pricing with the adjusted second probability, and generating the adjusted first SGP betting line based on the adjusted first pricing and the adjusted second pricing.

For at least one implementation of the computer readable medium, the counter-tilting operations may include determining whether the adjusted first SGP betting line aligns with the current single bet pricing and, when not aligned, iteratively repeating the counter-tilting operations until a currently adjusted first SGP pricing is aligned and the current single bet pricing.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of an aligned bet processing system for independent and/or live on-line gaming and in accordance with at least one implementation of the present disclosure.

FIG. 2 is a schematic for a server in accordance with at least one implementation of the present disclosure.

FIG. 3 is a flow chart illustrating a process for generating an aligned SGP in accordance with at least one implementation of the present disclosure.

FIG. 4 is a flow chart illustrating a process for counter-tilting a model used to generate an aligned SGP in accordance with at least one implementation of the present disclosure.

### DETAILED DESCRIPTION

Various implementations of the present disclosure describe independent bet processing devices, systems, and processes for on-line gaming involving SGPs and RSGPs.

For at least one implementation, a system is provided which generates, based on one or more determined correlations of a player Props with a team activity, an aligned pricing for a given SGP and/or RSGP (herein, collectively “SGPs”). For example, a first probability of a player, for a given team, scoring over a first given total amount of points may exist as a first bet while a second probability of that player's team scoring over a second given total amount of points may exist as a second bet. Given the commonality of the bets both depending on activities of the first player, pricing of the combined SGP needs to include a consideration of the correlation of the player's Props to the teams activity. To determine the correlation, the FES instantiates a correlation engine, as discussed further below, that determines the correlation of the first probability and the second probability, and based on such correlation, provides a pricing model for a given SGP. The pricing model is then aligned, by adjusting one or more counters, such that the output of the pricing model for a given betting line, when placed in an SGP bet, is aligned with the pricing model used for the given betting line, when placed as a single bet. For a non-limiting example, a given betting line may include a main line bet (a.k.a., a “money line” bet), which is placed on an ultimate outcome of an activity. Various implementations of the present disclosure align a first pricing for a main line bet, when placed as an SGP bet, with a second pricing for the main line bet, when placed as a single bet, by manipulating the counters used in generating the first pricing models used for the given SGP bet.

“Acceptable delay” is a delay of less than a given metric, for example and not by limitation, four seconds (4 s) under normal load conditions and thirty seconds (30 s) under heavy load conditions. For example, a delay between an outputting of a given bet settlement data packet by a back-end system element and a receipt of the given bet settlement data packet by a client centric system element may be an acceptable delay if less than four seconds (4 s) during a normal load condition, e.g., during a weekly PREMIER LEAGUE™ football match, a U.S. NFL™ game or the like, while a delay of thirty seconds (30 s) may be an acceptable delay under heavy load conditions, e.g., during a SUPER BOWL™ game, the WORLD CUP™ finals, or the like. Accordingly, it is to be appreciated that an acceptable delay may vary based on current system load conditions.

For at least one implementation, an “acceptable delay” is a delay of less than a given metric, for example and not by limitation, twenty seconds (20 s). For example, a delay of less than twenty seconds (20 s) between an outputting of a given bet settlement data packet by a back-end system element and a receipt of the given bet settlement data packet by a client centric system element may be an acceptable delay.

For at least one implementation, a given delay may be determined based on a quantification of one or more networked communications characteristics occurring between a back-end system element and an OGS element. It is to be appreciated that such one or more networked communications characteristics may vary over time and with use thereof.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“Application” herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Back-end system” (BES) herein refers to one or more computer servers, data storage devices, applications, and the like which, singularly and/or cooperatively, address one or more back-end on-line gaming functions. As used herein, a “back-end online gaming function” (BEOGF) is one or more data processing operations and communications operations performed by one or more servers which facilitate the providing of Props, results of in-game activities, and event results. A BES may include one or more servers, data stores, communications interfaces, user interfaces, security, power, busses, and related components. The BES components may be physically, logically, virtually or otherwise grouped and/or coupled to facilitate the one or more back-end on-line gaming functions including, but not limited to, those identified herein.

“Bus” herein refers to any known and/or later arising technologies which facilitate the transfer of data within and/or between devices. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating SGPs. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), the KAFKA protocol, as provided by the Apache Software Foundation and as further described at https://kafka.apache.org/documentation/#introduction (the contents of which are incorporated herein by reference), or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazom.com Inc., AZURE provided by Microsoft Corp., and others.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Content” herein refers to data that that may be presented, using a suitable presentation device, to a user in a humanly perceptible format. When presented to a human, the data becomes “information.” Non-limiting examples of content include gaming images and graphics such as those related to bet placement, or otherwise. Content may include, for example and not by limitation, one or more sounds, images, video, graphics, gestures, or otherwise. The content may originate from any source, including live and/or recorded, augmented reality, virtual reality, computer generated, or otherwise. The content may be presented to a given user using any user device and any user interface. Content may be stored, processed, communicated, or otherwise utilized.

“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” (which is also referred to herein as a “computer data”) herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient and/or non-transient form, as determined by any given state of such data, at any given time. For a non-limiting example, a given data packet may be non-transient while stored in a storage device, but transient during communication of the given data packet from a first device or system to a second (or more) device or system. When received and stored in memory, data storage device, or otherwise, the given data packet has a non-transient state. For example, and not by limitation, data may take any form including as one or more applications, content, or otherwise. Instructions, as further described herein, are a form of data.

“Data store” herein refers to any device or combinations of devices configured to store data on a temporary, permanent, non-transient, or other basis. A data store is also referred to herein as a “computer readable medium.” A data store may store data in any form, such as electrically, magnetically, physically, optically, or otherwise. A data store may include a memory devices, with non-limiting examples including random access memory (RAM) and read only memory (ROM) devices. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising memory and data storage device technologies may be utilized for a given data store. Available storage provided by a given one or more data stores may be partitioned or otherwise designated by the storage controller as providing for permanent storage and temporary storage. Non-transient data, computer instructions, or other the like may be suitably stored in a data store. As used herein, permanent storage is distinguished from temporary storage, with the latter providing a location for temporarily storing data, variables, or other instructions used for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient data with the data, while stored, being herein deemed to be non-transient data.

“Device” and “electronic device” herein refer to any known or later arising electrical device configured to, singularly and/or in combination, communicate, manipulate, output for presentation as information to a human, process, store, or otherwise utilize data. Non-limiting examples of devices include user devices and servers.

“Front-End System” (FES) herein refers to one or more user devices, servers, data storage, communications interfaces, and related components which, singularly and/or cooperatively, address one or more gaming on-line gaming functions. As used herein, a “Front-End Online gaming function” (FEOGF) is one or more data processing and/or communications operations performed by one or more user devices and/or servers which facilitate one or more of correlations of two or more activities to facilitate pricing of a given SGP and aligning of the pricing of a given bet when placed as a single bet or as an SGP bet. A FES may include one or more user devices, servers, data stores, communications interfaces, user interfaces, busses, and related components. The FES components may be physically, logically, virtually or otherwise grouped and/or coupled to facilitate the one or more gaming online gaming functions including, but not limited to, those identified herein.

“Instruction” (which is also referred to herein as a “computer instruction”) herein refers to a non-transient processor executable instruction, associated data structures, sequence of operations, program modules, or the like. An instruction is described by an instruction set. It is commonly appreciated that instruction sets are often processor specific and accordingly an instruction may be executed by a processor in an assembly language or machine language format that is translated from a higher level programming language. An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient and/or non-transient basis, as may arise for any given data, content and/or instruction.

“Live” herein when used to refer to on-line gaming, refers to a SGP that occurs during a given event and before a given event activity occurs. A non-limiting example of a “live” bet is a bet placed during an NFL™ football game and before a given event activity occurs. For a non-limiting example, a live bet is a bet placed after an expiration of a regular time period for the football game (the event) where the bet chooses a result (the event activity) of an upcoming coin-toss (e.g., “heads” or “tails”)—the coin toss determining who gets the option to receive a kick-off of the football during an overtime period. By comparison, a non-limiting example of a non-live bet (herein, also referred to as an “independent bet”) is a bet placed for an activity for a given event before the event itself begins, with the bet, for example, being placed as to the ultimate winner of the event (the winner=the event activity).

“Module” herein refers to and, when claimed, recites definite structure for an electrical/electronic device that is configured to provide at least one feature and/or output signal and/or perform at least one function including the features, output signals and functions described herein. A module may provide the one or more functions using computer engines, processors, computer instructions and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module. Likewise, a PHOSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.

“Power Supply/Power” herein refers to any known or later arising technologies which facilitate the use of electrical energy by a device. Non-limiting examples of such technologies include batteries, power converters, inductive charging components, line-power components, solar power components, and otherwise.

“Processor” herein refers to one or more known or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

“Real-time” herein refers to a presentation of information to a human that occurs substantially simultaneously with a resolution of an event, such as an activity with respect to which a bet has been placed for an SGP.

“Security Component/Security” herein refers to any known or later arising processor, computer instruction, and/or combination thereof configured to secure data as communicated, processed, stored, or otherwise manipulated. Non-limiting examples of security components include those implement encryption standards, such as an Advanced Encryption Standard (AES), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include database servers, file servers, application servers, web servers, communications servers, virtual servers, computing servers, and the like. Servers may be combined into clusters (e.g., a server farm), logically or geographically grouped, or otherwise. Any known or later arising technologies may be used for a server.

A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Substantially simultaneous(ly)” herein refers to an absence of a greater than expected and humanly perceptible delay between a first event or condition, such as a completion of a gaming activity, and a second event or condition, such as a presentation of a bet settlement for a bet placed with respect to the gaming activity. Substantial simultaneity may vary in a range of quickest to slowest expected delay, to a moderate delay, or to a longer delay. For at least one implementation, substantial simultaneity occurs within an acceptable delay (as described above).

“User Device” herein refers to a device configured for use by a human being to one or more of communicate, present, process, and store data. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Aligned SGP Processing System 100

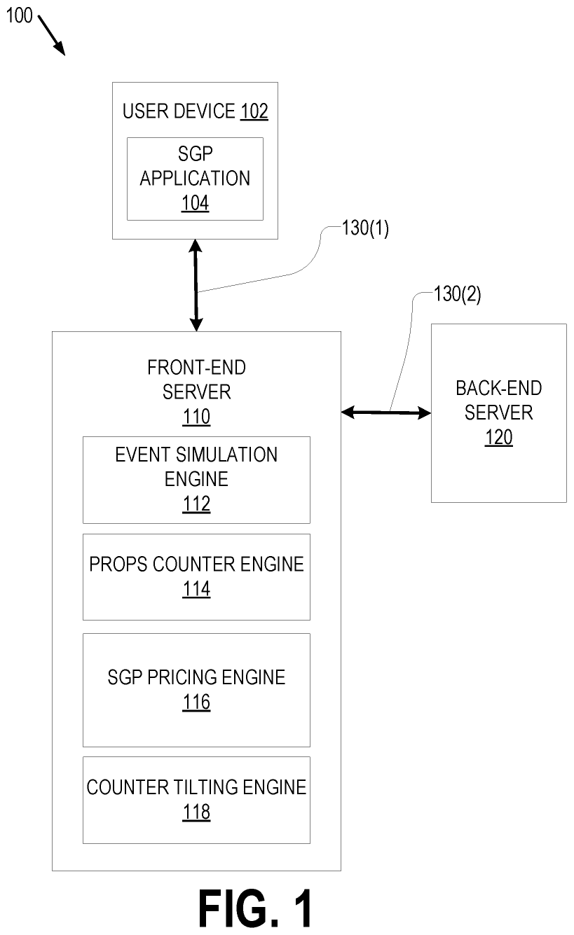

As shown in FIG. 1 and for at least one implementation of the present disclosure, an aligned SGP processing system 100, may include: a user device 102, executing an SGP engine 104; a FES 110 executing an event simulation engine (“ESE”) 112, a Props Counter Engine (“PCE”) 114, an SGP pricing engine (“SPE”) 116, a Counter Tilting Engine (“CTE”) 118, and a BES 120 providing PROPs data and single line pricing data, for a given bet, to the FES 110. The system 100 may be configured to facilitate operations executed by the FES 110 based on Props, market prices and other data provided by the BES 120. A first coupling 130(1) couples the user device 102 with the FES 110 and a second coupling 130(2) couples the FES 110 with the BES 120.

### User Device 102

For at least one implementation, the system 100 may include one or more user devices 102. A user device 102 may include one or more device components including, but not limited to, a processor, a data store, a user interface, a communications interface, a power supply, a security component, and other components. The one or more components may be provided with the user device 102 or elsewhere; e.g., a remote data store accessible to the device by one or more couplings may be used.

The user device 102 may be configured to execute an SGP application 104. For at least one implementation, the SGP application 104 may be an online gaming application which facilitates a user's review, selection and input of one or more on-line SGP bets, wherein pricing models for a given SGP bet have been aligned for pricing models for a corresponding single bet, and for one or more events, information regarding the status and final resolution of the events or elements thereof, and settlement of bets placed relative to such events and/or elements thereof.

For a non-limiting example, an event may be a given currently occurring or future occurring NFL™ game, e.g., the New England Patriots vs the Kansas City Chiefs. A first betting option for a player activity for the event may be a final score, a winner, a loser, or the like. A second betting option for an activity for the event may be a participant performance metric for one or more players (e.g., a quarterback passing for over three hundred (300) yards). The first betting option and the second betting option may be combined into an SGP. The SGP application 104 may facilitate selection of a user of two or more betting options, in an SGP, on a predefined basis (herein, a “Prepack SGP”). For at least one implementation, the SGP application 104 may facilitate live (non-predefined) SGP generation by a user, of a user device 102, identifying two or more betting activity options that are to be combined into an SGP (herein, a “Built Bet SGP”). For at least one implementation and with respect, e.g., to the first betting option, the pricing used for the SGP bet is aligned with pricing for the first betting option, when placed as a single bet.

For at least one implementation, any event and/or activity for an event may be a subject of one or more Prepack SGPs and/or Built Bet SGPs with respect to which pricing of the bet elements therein are aligned with corresponding single bet lines. As a given event progresses, the SGP application 104 may provide updates on existing bets, new betting options including new Prepack SGP and Built Bet SGP options, odds adjustments, and the like with respect to the event and/or activities thereof. For at least one implementation, one or more of the betting options and/or odd adjustments may be based upon alignments of pricing models used for a given betting line when placed as an SGP bet with pricing models used for the given betting linen when placed as a single (non-SGP) bet. When the event or activity thereof concludes, the first application 104 may provide the given user with updates on winnings/losses, or other information pertaining to the event or activity thereof, SGP, and other betting information. For example, an SGP that includes an activity of a player passing for over a certain number of yards, and a minimum total score for a team may be updated to indicate that a given activity has occurred (and may be designated as “in the money”) while another given activity remains to be determined. The SGP application 104 may be configured to provide, for presentation to a user, any information relevant to a given bet, betting event, a betting activity, an SGP, combinations thereof, settlements of bet, account balances, or the like. Other BESs 120 may be utilized to provide data to the FES 110 to provide such betting information to a user.

### FES 110

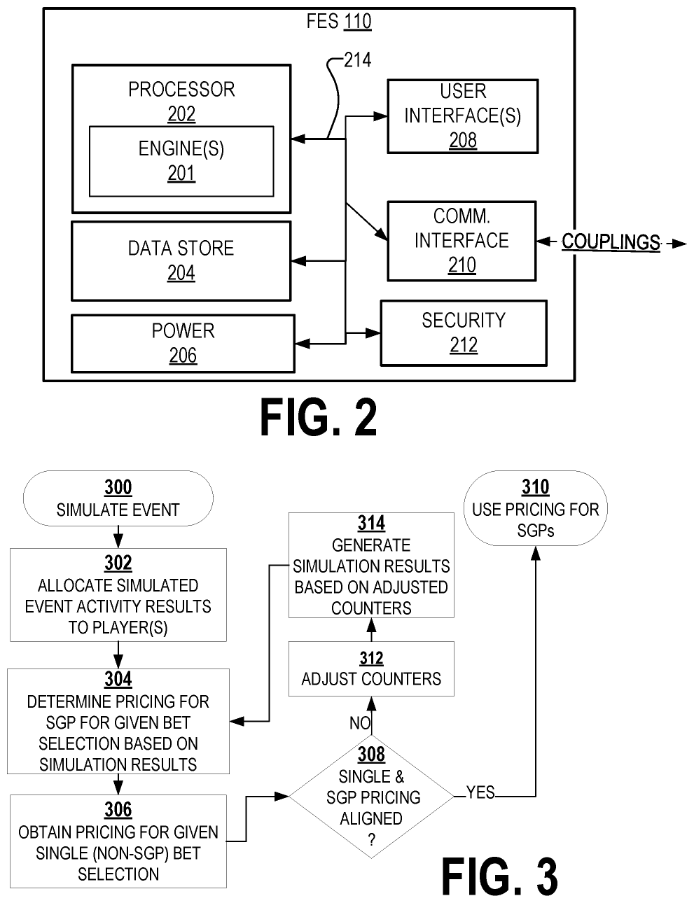

As shown in FIG. 2, an FES 110 may include a processor 202 which executes non-transient computer instructions, stored in the data store 204, for executing applications, instantiating one more computer engines 201, and performing other device-related operations. The computer engines 201 instruct the server and/or other system 100 components to perform various operations which facilitate (among other operations) generation, processing, communication, storage, and the like of SGPs and the alignment of pricing models used for a given betting line when placed as a single bet with pricing models used for the given betting line when placed as an SGP bet. Communication of data between an FES 110 and another system 100 component may utilize a communications interface 210 that respectively couples the FES 110 with the other system component(s). The FES 110 may further include one or more user interfaces 208, power 206, security 212, and other commonly utilized components for one or more computers and/or computer servers. The server components may be communicatively coupled by a bus 214.

For at least one implementation, the FES 110 may be configured to manage aspects of SGP generation, pricing, pricing model alignments, and the like. For at least one non-limiting example, the FES 110 may be configured to execute one or more computer engines with non-limiting examples including: the event simulation engine (ESE) 112 which may be configured to simulate events based on data received from one or more BESs 120; the Props counter engine (PCE) 114 which may be configured to generate counters used for allocating points to users based on PROPS data for SGPs; the SGP pricing engine (SPE) 116 which may be configured to utilize the counters generated by the PCE 114 and based on counters received from the ESE 112 to determine pricing for a given SGP based on combinations of two or more event activities specified by an operator of the FES 110 (e.g., for a Prepack SGP) or selected by a user (e.g., for a Built Bet SGP) for a given SGP; and the Counter Tilting Engine (CTE) 118 which may be configured to align pricing models for an SGP bet with pricing models for a single bet and with respect to a given betting line such as a main line bet, an over/under bet, or another betting line.

### BES 120

For at least one implementation, the system 100 may include a BES 120. The BES 120 may include one or more servers that receive data regarding event activities (e.g., for past, present and/or future activities), compiles and processes such data into one or more event lines, Props, and/or other combinations of events and activities (herein “betting data”) and provides the betting data to the FES 110. The FES 110 utilizes the betting data (in whole or in part) to facilitate generation of and pricing for SGPs, align pricing for SGP and single bets, for a given betting line, track event activities in relation to existing SGPS, and otherwise perform bet related processing activities.

As shown in FIG. 3 and for at least one implementation, a process for generating aligned model SGPs may include, as per Operation 300, simulating a given event. For at least one implementation, the event simulation engine (ESE) 112 may generate one or more simulations for a given event based on any number of variables, time periods, activities, players, or other betting data. The ESE 112 may generate a simulated event in advance and/or real-time based on betting data stored in one or more databases coupled to the FES 110, generated independently by the FES 110, provided by the BES 120 to the FES 110, or otherwise obtained by the FES 110. Non-limiting examples of betting data that the ESE may consider in simulating an event include individual participant status (e.g., active, inactive, injured, benched, in “foul trouble,” or otherwise), event status (e.g., prior to event start, during first period, during intermission, during final period, or otherwise), weather conditions (e.g., clear skies, indoors, snowing, wind conditions, rain, or otherwise), location (e.g., neutral site, event participating team (or person) site, or otherwise), and any other data that may be relevant to simulating a given event.

It is to be appreciated that a given event may include one or more participants and conditions for the event may vary depending on the participant. Activities in an event may also vary by player, participant, or otherwise. For example, an NFL quarterback (a player and a participant) may be involved in passing touchdown activities but not involved in blocked punt activities. Betting data may be venue specific, for example, a golf event may include betting data indicative of course layout, with a given course layout being more or less favorable for a given participant versus another participant. Similarly, a given event, such as an NFL game in Buffalo, New York state in January, may be more favorable to the home team (a first player) versus an opponent team (a second player) from Florida (or a given participant thereof, e.g., a quarterback who historically underperforms in wintry weather). The ESE 112 may be configured to consider such betting data in generating a simulated event results. Any data available to the ESE 112 may be considered when generating simulated event results, event activity results, and/or event activity category results.

For at least one implementation, the ESE 112 may generate the simulated results on an interval and repeated basis while the event occurs or otherwise. For example, simulated results may be generated by the ESE 112 prior to an event commencing, at the beginning of the event, while the event occurs, or the like. The ESE 112 may generate simulation results on event activity and/or event activity category bases, such as on a possession by possession basis, on an elapsed time for the event basis, or otherwise. The simulated result basis may be predetermined, determined during the event, randomly determined, or otherwise determined in view of then available betting data. The event simulation results generated by the ESE 112 may correspond to one or more Prepack SGPS and/or Built Bet SGPs, including Built Bet SGPs generated by a user on a substantially real-time basis with a given event and/or a given event activity occurring. For example, a Built Bet SGP requested by a user based on a distance of an upcoming field goal activity (a first betting option) and in view of a total score (a second betting option) during a then-occurring NFL game.

The ESE 112 may be configured to utilize artificial intelligence and machine learning processes (herein, “AI”) including known and/or later developed AI processes, to generate the simulated results.

The ESE 112 may be configured to assign simulated results to one or more event activities and/or event activity categories. For example, a simulated result may be an increase in a team's score—an example of an event activity. The ESE 112 may further categorize the increase in the team's score into one or more event activity categories. Event activity categories may be event specific, event activity specific, participant specific, or otherwise designated. For example, during an NFL game a team's score (an event activity) may increase. Such score increase may be categorized into one or more event activity categories with non-limiting examples including: passing touchdown, rushing touchdown, field goal, safety, defensive interception for a touchdown, fumble recovery for a touchdown, blocked-punt return for a touchdown, punt return for a touchdown, blocked field goal return for a touchdown, kick-off return for a touchdown, and the like. Any number of event activity categories may be used the ESE 112.

The ESE 112 may be configured to generate simulated results on any quantifiable basis for an individual participant or collection thereof. For a non-limiting example, a scoring result may be quantified as attributable to multiple participants (e.g., a given quarterback completing a touchdown pass with a given receiver), or another basis.

The ESE 112 may be configured to generate simulated results based on betting data received during a given event. Such betting data may include lines provided by SWISH, scoring results provided by Sportradar, and/or other betting data.

For at least one implementation, a series of Kalman filters may be utilized by the ESE 112 to generate the simulated results which the ESE 112 may further categorize into one more event activity categories and associated with one or more players, individual participants, and/or collection of individual participants. The simulated results may be based on betting data from historical results, current activities in a given event, on probabilities associated therewith, and the like. It is to be appreciated that such probabilities themselves may be further dependent upon other factors, such as location on a playing surface in which a given activity (leading to an increased points result occurs) or other factors, as represented by betting data available to the ESE 112 at a given time.

As per Operation 302, the process may include the event simulation engine (ESE) 112 providing the simulated results to the Props counter engine (PCE) 114. The PCE allocates the simulated results to one or more individual participants using one or more “counters.” For at least one implementation, the PCE 114 may adjust the simulated results based on actual results for a live event. The actual results may be provided as betting data by a BES 120 such as SWISH and Sportradar. The actual results and/or betting data may be provided for the given event on a team, player, participant, collection thereof, or other basis.

As used herein, a “counter” is an array (or matrix), generated by the PCE 114, that indicates whether a given individual participant associated with a given player (e.g., a team) and a given event activity category is producing a given result. For example, an event activity category of “baskets scored” may be associated with actual result of “baskets scored counter” that is specified in the betting data received by the FSE 110 from a BES 120. The counter may be associated with any given level of event activity category specificity. For a non-limiting example, counters for a basketball game may include arrays for total baskets scored, two-point baskets scored, three-point baskets scored, free-throws scored, or otherwise. During an event, the Props counter engine (PCE) 114 may count, for an individual participant, three-point baskets scored by that individual and allocate such count to a simulated result for the participant's team scoring three-point baskets or with respect to another event activity category.

The PCE 114 may generate one or more “bet selections” for a given individual participant in a given event. The bet selection(s) may be based on the counters and one or more probabilities of a given result occurring. The probabilities may be generated by the PCE 114 based on one or more simulated results generated by the ESE 112. As used herein, a “bet selection” is a probabilistically weighted counter for a given participant (e.g., a member of the team) producing a given participant result. The bet selection is determined in view of a simulated result that a given player (e.g., a team) is predicted to generate and in view of one or more simulated results for the one or more event, actual event results, and other betting data. The bet selection may be specified on an event, event activity, or event activity category basis.

For at least one implementation, a bet selection may be generated based on a probability that a given participant will be over (a “p-over” or “PO” probability) or under (a “p-under” or “PU” probability) a given SGP line. Herein, an SGP line (“SGPL”) provides odds given result of an activity occurring and not occurring for a given event. For example, an SGPL may be the total points scored by a participant for a given event (e.g., player Y scoring 20 points in a basketball game between team A and team B). For at least one implementation, a PO or a PU may be determined using Equations 1-4 (with PU being shown for purposes of this description).

$${p}_{under} = \frac{1}{\vert I \vert} {\sum }_{i} {F}_{binom} ( line , {N}_{i} , p ) \qquad Equation 1$$

where “|I|” is number of simulations,
where Nᵢ is the total number of team Props generated in an i-th simulation;
where F_{binom}(line, N, p) is a cumulative probability of a binomial distribution as set forth in Equation 2;
where i is index of simulation; and
where p is assignment probabilities of the team props to the player.

$${F}_{binom} ( line , {N}_{i} , p ) = {\sum }_{j < line} {C}_{j}^{N} {{p}^{j} ( 1 - p )}^{N - j} \qquad Equation 2$$

It is to be appreciated that a derivative of the cumulative probability (F_{binom}(line, N, p)) can be computed using Equation 3.

$$\frac{d}{dp} ( {C}_{j}^{N} {{p}^{j} ( 1 - p )}^{N - j} ) = {C}_{j}^{N} {{p}^{j} ( 1 - p )}^{N - j} \frac{( j - Np )}{p ( 1 - p )} \qquad Equation 3$$

And the probability of a new PO or PU can be computed using Newton's Method (which is also known as the Newton-Raphson method) as per Equation 4.

$${p}_{new} = {p}_{old} - \frac{f ( {p}_{old} )}{{f}^{′} ( {p}_{old} )} \qquad Equation 4$$

For at least one implementation, a minimum of three (3) iterations of the Newton method may be used by the PCE to generate a given PO/PU bet selection for a given line.

Similarly, for at least one implementation, the PCE 114 may be configured to generate a bet selection for a player (e.g., a team) score based on averages of various scoring possibilities. For example, in a basketball game, a team (a player) or a participant may have a given scoring event, which results in points being awarded to the team, in one of three different ways: as one-point (e.g., by making a free throw) (“N₁”), as 2-points (e.g., by making a lay-up or two free throws) (“N₂”), or as 3-points (e.g., by making a three-point shot, a two-point shot and a free throw, or three free throws) (“N₃”). Based on historical results from past events, statistical averages can be determined, namely: N₁, N₂, and N₃. Using Equation 4, PO or PU can be determined using a Poisson distribution as shown in Equations 5 and 6, as follows:

$${f}_{pois} ( j , μ ) = {e}^{- μ} \frac{{μ}^{j}}{j !} , \qquad Equation 5$$

where μ is expected occurrences of some type of scores.

$${p}_{under} = {\sum }_{{j}_{1} + 2 {j}_{2} + 3 {j}_{3} < line} {f}_{pois} ( {j}_{1} , {\overline{N}}_{1} p ) {f}_{pois} ( {j}_{2} , {\overline{N}}_{2} p ) {f}_{pois} ( {j}_{3} , {\overline{N}}_{3} p ) \qquad Equation 6$$

Using a derivative of the Poisson distribution and the Newton method (as per Equation 4), the probability of a given scoring event occurring can be determined and utilized in determining a given bet selection.

For at least one implementation, the PCE 114 may modify a bet selection by iteratively adjusting it, during an event based on actual event activity results, as reported on a team and individual participant basis, until an individual participant's event activity predicted results correlate with a team's (or another player's) actual event activity results for the live event (as represented by one or more counters). For example, a counter tracking three-pointers for participant A may be associated, in a bet selection, with a probability of participant A making 20% of team Y's three-pointers. This bet selection may be adjusted, during an event, when a participant B has gotten “hot” and is scoring more than an expected number of three-pointers. Given participant B's productivity, as represented by a corresponding counter for player B increasing while the counter for player A is lagging behind an expected result, the probability of participant A taking a three-pointer can be reduced 20% to another value while the probability of participant B taking a three-pointer increases and the teams overall probability of taking a three-pointer remains unchanged. Accordingly, the PCE 114 can update a given bet selection so that the simulated results are adjusted on a participant basis and in view of a team's overall results-resulting in a correlation of participant results to team results and probabilities thereof for future results that can be identified in a given bet selection and used by other processes to generate an SGP.

For another example, the bet selection indicates a probability that player X (an individual participant) will contribute to ten of the twenty baskets scored (an event activity) by team Y (a team and a player) in the simulated result of a basketball game contest between team Y versus team W (an event). Further, the bet selection may indicate a probability that player X's baskets scored include a given minimum number of three-point baskets scored (an event activity category). Based on actual event results, as indicated by one or more participant's counters, these probabilities and the accuracy of any corresponding bet selections may be increased to provide an accurate SGP, where an accurate SGP is one where actual results versus predicted results differ by less than three percent (3%).

The PCE 114 may output the bet selections as one or more simulation results to the SGP pricing engine (SPE) 116. The simulation results may be generic, market specific, or otherwise specified.

As per Operation 304, the process may include the SPE 116 determining initial pricing for a given bet selection (e.g., an over or under bet pricing), as received from the PCE 114 and for a given SGP, based on the simulation results provided in the given bet selection. The pricing for a given SGP generated by the SPE 116 reflect correlations identified by the simulation results between individual participant results, as provided in the counter(s), and other player (e.g., team) results for a given event, event activity, and/or event activity category.

As per Operation 306, the process may include obtaining pricing for a single (non-SGP) bet for the given bet selection (e.g., a mainline bet). For at least one implementation, the single pricing may be determined by the ESE 112, obtained from a BES 120, or otherwise obtained.

As per Operation 308, the process may include determining if pricing for the single bet line and a first SGP betting line are aligned. As used herein, “aligned” means that the pricing does not vary and is identical. For other implementations, the pricing may vary by a pre-determined variance. For example, a pre-determined variance may be used with volatile betting lines and with the amount of variance increasing/decreasing based on a volatility of a given betting line. For example, a betting line that is changing on a repeated basis, such as once every ten seconds, may have some variance than one that is constant or changes on an infrequent basis, such as once an hour, where no variance may be used. If “YES,” the process may proceed to Operation 310 with the SGP pricing being utilized for the given bet selection. If “NO,” the process may proceed to Operation 312.

As per Operation 310, the process may include utilizing the SGP pricing for pricing the given bet selection (e.g., a mainline bet).

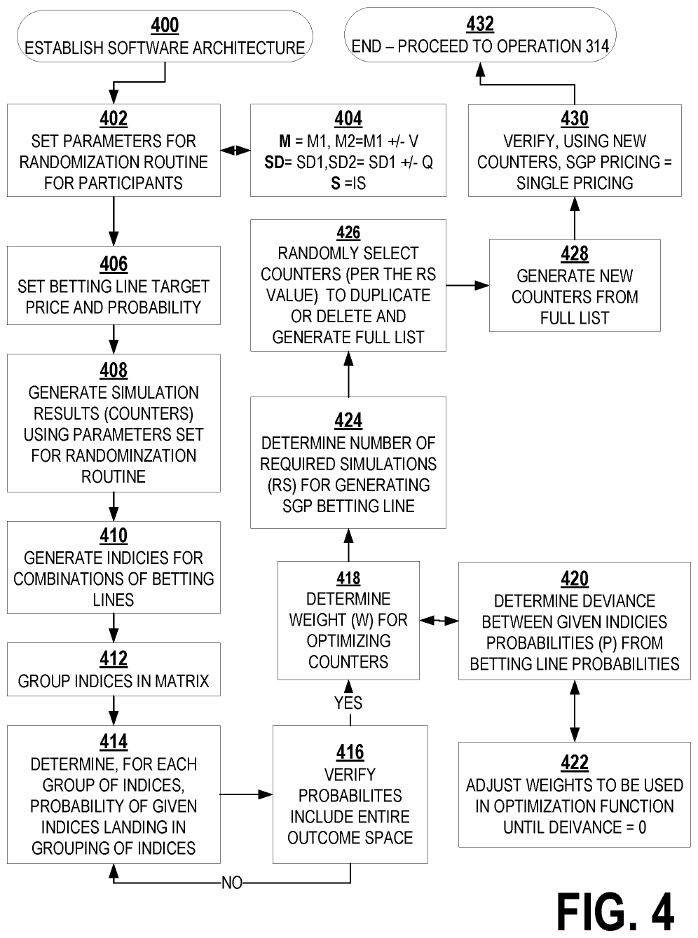

As per Operation 312, the process may include adjusting the counters used in the SGP pricing. For at least one implementation, a process for adjusting the counters is shown in FIG. 4 and further described below.

As per Operation 314, the process may include generating adjusted simulation results based on the adjusted counters. The adjusted simulation results may be provided to Operation 304 in addition to, in place of, or otherwise with the simulation results previously provided by Operation 302. The adjusted simulation results may be used to determine adjusted pricing for the SGP. Such adjusted pricing may then be compared, as per Operation 308, with the single (non-SGP) pricing previously obtained and/or then obtained, as may occur for a “live” event. The process may then proceed to Operations 310 and/or 312-314 with further adjustment to the counters and the simulation results generated based on the adjusted counters. It is to be appreciated that adjustments to the counters may occur on an iterative basis until the SGP pricing is aligned with the single (non-SGP) pricing for a given a bet selection. For a live event, it is to be further appreciated that the single (non-SGP) pricing may change on a continual or other basis as the underlying activity with respect to which the betting line is established change. Such changes in the single (non-SGP) pricing may result in further changes to counters used in the SGP pricing, so that both pricings are aligned before, during, and after the activity for the betting line ends. As used herein, an SGP pricing is aligned to a given single (non-SGP) pricing, for a given betting line, when the SGP pricing is identical to the single pricing.

As shown in FIG. 4, at least one implementation of a process is shown for adjusting counters used to price an SGP bet, for a given betting line (e.g., a mainline bet) so that the SGP bet is aligned with a single (non-SGP) bet for the given betting line.

As per Operation 400, the process may include establishing a software architecture used by the FES processor 202 to adjust the counters. For at least one implementation, the software architecture may include use of the python programming language configured to run open-source software routines including an optimization routine and a randomization routine, for example, NumPy™, for generating random numbers.

As per Operation 402, the process may include setting the parameters to be utilized for the randomization routine (e.g., NumPy) for the participants in a given activity for which a betting line is being set. A NumPy routine typically utilizes three parameters, a mean (“M”), a standard deviation (“SD”), and a number of initial simulations (“IS”) to be run. For example, for a single participant event, such as a bicycle time trial event, a betting line may include a mean that is a time for an average participant to complete the event, a standard deviation from the mean time, and a number of simulations to be run. For a two participant event, such as a basketball game, a mean may include a mean score for a given team, e.g., 50 points scored in a given period of the activity (e.g., a first half), a standard deviation from the mean score (e.g., 4 points), and a number of simulations to be run.

For at least one implementation where there are two participants in a given activity, the process may include setting a first mean (M1) for a first participant in a given period of the activity (e.g., the first half) at a score that is a given first variable (“V”) greater or less than a second mean (M2) for a second participant in the given period of the activity. For activities where results thereof are determined in integers values, V is an integer. For activities where results thereof are determined in portions of integers (e.g., bicycle races), V may be any real number. For at least one implementation, V is a negative value when the second participant is believed to be likely to score more points than the first participant. For at least one implementation, V is a positive value when the second participant is likely to score less points than the first participant. It is to be appreciated that V cannot equal zero (0), as such a setting would essentially nullify a betting line that provides odds and pricing for one participating prevailing over the other participant, in points scored, for a given period for the given activity. It is to be appreciated that the given period may include any partial time, full time or other periods for the given activity. For a non-limiting example, for a basketball game activity, M1 may be set at 51, V1=1 and M2=52.

For at least one implementation and returning to the two participant activity, a standard deviation (SD) from the mean (M) for a given participant for the given period of the activity is specified. For example, a first standard deviation (SD1) may be specified for the first participant, and a second standard deviation (SD2) may be specified for the second participant. SD1 may be greater than, less than or equal to SD2. When greater than or less than, a second variable (“Q”). For activities where results thereof are determined in integers values, Q is an integer. For activities where results thereof are determined in portions of integers (e.g., bicycle races), Q may be any real number. For at least one implementation, any number of simulations(S) may be run for each of the participants in a given activity. For at least one implementation, one-thousand five hundred simulations may be run for each participant in the given activity. For at least one implementation, M1, V, M2, SD1, SD2, and Q may be determined based on previously established betting lines, historical results of simulations, or other data. Such other data may be provided by one or more other engines 201 executed by the FES 200 and/or by one or more BESs 120.

As per Operation 406, the process may include setting one or more target prices and probabilities for one or more betting lines for one or more, including for at least one implementation each, of the participants in the given activity (e.g., a basketball game). For example, for a mainline bet a probability of a home team (in the basketball game) exceeding a total score for a given period (e.g., a first half (“FH”) period, a second half (“SH”) period, or a full game (“FT”) period) may be specified. Non-limiting examples of target prices and probabilities that may be specified include FT mainline home (and/or away) team price, FT mainline home (and/or away) team handicap probability, over/under price, over/under handicap, and others. It is to be appreciated that one or more target prices and handicap probabilities thereof may be set. For at least one implementation, a target price and a handicap probability may be set based on target prices and probabilities utilized for a single (non-SGP) betting line for a given activity.

As per Operation 408, the process may include generating simulation results (e.g., Counters) for each participant and using the parameters set for the randomization routine, per Operation 404. For at least one implementation, counters are generated for each of the target prices and probabilities set per Operation 406.

As per Operation 410, the process may include generating an indices for each of the combinations of betting line options based on the counters generated per Operation 408. The indices may combine, for example, the counters that indicate that a probability of a given betting line and/or a combination of betting lines was satisfied (i.e., greater than one (1)) for a given participant in the given activity. For example, an indices may combine the counters that indicate that a home team exceeded each of a mainline betting option, a handicap betting line option, and an over/under betting line option.

As per Operation 412, the process may include generating a matrix which includes two or more groupings (each grouping being an “indices group”) of the indices generated per Operation 410. For at least one implementation the matrix may identify each of the indices by a unique index number.

As per Operation 414, the process may include determining a probability (“P”) that a given indices, in a given indices group, would be categorized into the given indices group. For at least one implementation, the probability (P) determination indicates a likelihood that a given combination of results, as reflected by a given indices which, as generated per Operation 410 is a grouping of two or more counters, will occur.

As per Operation 416, the process may include verifying that a sum of the probabilities (P), as generated per Operation 414, equals one (1) and includes the entire outcome space. If the sum is not one (1), the probabilities are recalculated, as per Operation 414. When the sum equals one (1), the process proceeds to Operation 418.

As per Operation 418, the process may include determining a weight (“W”) to be used in optimizing the counters to be selected for pricing each given SGP betting line. For at least one implementation, the process of determining the weights used for the betting lines may be accomplished per Operations 420 and 422. When the weight (W) is determined, the process proceeds to Operation 424.

As per Operation 420, the process of determining weights W used to optimize counters may include determining a deviance between a given indices probability (P), as calculated per Operation 414, from a betting line probability, as set per Operation 406. When an absolute value of the deviance is greater than zero (0), the process proceeds to Operation 422. When the absolute value of the deviance is zero (0), the given weight as specified per Operation 422 is returned to Operation 418.

As per Operation 422, the process may include adjusting the weights to be used with the probabilities (P) by iteratively adjusting (increasing or decreasing) a given W relative to a pre-determined variance weight. It is to be appreciated that the adjusting of the weights may occur in a massively parallel processing operation as applied across the numerous counters, as grouped into the indices, as per Operation 410, and the groupings, as per Operation 412. The output of Operation 422 includes an adjusting weight used by the process steps of Operation 420 to determine the deviance. Operations 420 and 422 may be iteratively performed until a deviance of zero (0) is obtained for a given betting line.

As per Operation 424, the process may include optimizing the number of simulations and counters produced thereby that are needed in order for the pricing and probabilities used in an SGP betting line correspond to the pricing and probabilities used for a single (non-SGP) betting line (as set per Operation 406). For at least one implementation, the process may include determining an initial wanted number of desired simulations (“DS”) to utilize. For at least one implementation, DS<IS. Based on DS, the process includes determining how many additional (+) or lesser (−) simulations are required (herein, the required Simulation (“RS”) for the pricing and probabilities for the SGP and single betting lines to correspond. For at least one implementation, RS is an integer. For at least one implementation, RS is determined by utilizing an SciPy™ optimization routine that seeks to minimize differences between the prices and probabilities as initially determined for one or more SGP betting lines, as determined per Operations 408-416, with those specified per Operation 406. Such optimization routines are well known in the art and any known or later developed optimization routine may be utilized.

As per Operation 426, the process may include randomly selecting the simulations (RSs) for duplication (when RS>0) or deletion (when RS<0), from the simulation results generated per Operation 408. For at least one implementation, the number of initial simulations (IS) utilized, as specified per Operation 404, may be adjusted such that the number of required simulations (RS) needed is not a positive value, that is RS<=0. Such an adjustment may be made to avoid concerns of unreliable results arising when one or more previous simulation results is duplicated. Upon duplicating or deleting simulation results, a full list of new indices and groups is generated.

As per Operation 428, the process may include generating a new counter that includes the full list generated per Operation 426.

As per Operation 430, the process may include verifying, using the new counters, that the SGP pricing matches the single (non-SGP) pricing for a given betting line. If the pricings do not match, the process may return to Operation 418. If the prices match, the process proceeds to Operation 432.

As per Operation 432, the process ends with the new counters being output to other engines 202 used for pricing SGPs, as per Operation 310.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. An aligned single game parlay system comprising:
a user device having a processor executing first non-transient computer instructions which instantiate a single game parlay (“SGP”) application;
wherein the SGP application provides a SGP application user interface which facilitates selection, by a user of the user device, of an SGP bet including a first SGP betting line and a second SGP betting line for an event;
wherein the first SGP betting line specifies a first SGP pricing for a first activity for the event;
wherein the second SGP betting line specifies a second SGP pricing for a second activity for the event; and
a front-end server having a front-end processor executing second non-transient computer instructions which instantiate a Counter Tilting Engine (“CTE”) which performs CTE operations that include:
aligning the first SGP pricing with a single bet pricing, for a single bet line for the first activity for the event; and
wherein the front-end server outputs to the SGP application, for presentation to the user, an adjusted first SGP betting line that is aligned with a current single bet pricing for the first activity for the event.

2. The aligned single game parlay system of claim 1,
wherein the CTE aligns the first SGP pricing with the current single bet pricing by further performing CTE operations that include:
receiving an initial SGP pricing for the first SGP betting line;
wherein the initial SGP pricing is determined based on an initial set of counters;
receiving an initial single bet pricing for the single bet line;
determining if the initial single bet pricing and the initial SGP pricing are aligned;
when aligned, using the initial SGP pricing for the first SGP betting line; and
when not aligned,
contemporaneously adjusting the initial set of counters to provide an adjusted set of counters; and
outputting the adjusted set of counters; and
wherein, based on the adjusted set of counters, the front-end server iteratively generates one or more instances of an adjusted first SGP pricing until the adjusted first SGP pricing aligns with the current single bet pricing.

3. The aligned single game parlay of claim 2,
wherein the initial set of counters includes at least one thousand counters.

4. The aligned single game parlay system of claim 2,
wherein a counter is an array that indicates whether a given participant in the first activity will produce a given result.

5. The aligned single game parlay system of claim 2,
wherein the adjusting of the initial set of counters to provide the adjusted set of counters further includes:
duplicating at least one counter selected from the initial set of counters to provide a duplicated counter; and
adding the duplicated counter to the initial set of counters to produce the adjusted set of counters; and
wherein the adjusted set of counters includes the initial set of counters plus the duplicated counter.

6. The aligned single game parlay system of claim 2,
wherein the adjusting of the initial set of counters to provide the adjusted set of counters further includes:
deleting, a deleted counter, from the initial set of counters; and
wherein the adjusted set of counters includes the initial set of counters less the deleted counter.

7. The aligned single game parlay system of claim 2,
wherein the front-end processor further executes third non-transient computer instructions which instantiate an Event Simulation Engine (“ESE”) which performs ESE operations comprising:
receiving the adjusted set of counters from the CTE;
generating, based on the adjusted set of counters, adjusted simulations for the first activity; and
outputting the adjusted simulations.

8. The aligned single game parlay system of claim 7,
wherein the front-end processor further executes fourth non-transient computer instructions which instantiate a Props Counter Engine (“PCE”) which performs PCE operations including:
receiving the adjusted simulations from the ESE;
determining, based on the adjusted simulations, an adjusted first probability of a future result occurring for the first SGP betting line;
determining, based on the adjusted simulations, an adjusted second probability of the future result not occurring for the first SGP betting line; and
outputting the adjusted first probability and the adjusted second probability.

9. The aligned single game parlay system of claim 8,
wherein the front-end processor further executes fifth non-transient computer instructions which instantiate an SGP Pricing Engine (“SPE”) which performs SPE operations comprising:
associating an adjusted first pricing with the adjusted first probability;
associating an adjusted second pricing with the adjusted second probability;
generating the adjusted first SGP betting line based on the adjusted first pricing and the adjusted second pricing; and
wherein the CTE receives the adjusted first SGP betting line;
wherein the CTE determines whether the adjusted first SGP betting line aligns with the current single bet pricing; and
when not aligned, the front-end processor iteratively repeats the CTE operations, ESE operations, PCE operations and SPE operations until a currently adjusted first SGP pricing and the current single bet pricing align.

10. The aligned single game parlay system of claim 9, further comprising:
a back-end server communicating, to the front-end server, betting data for the first activity for the event;
wherein the back-end server communicates the betting data to the front-end server on a real-time basis while the first activity occurs; and
wherein the front-end server, based on the betting data, updates the current single bet pricing for the single bet line.

11. The aligned single game parlay system of claim 10,
wherein the front-end server further aligns the second SGP betting line with a second single bet line;
wherein the second single bet line specifies a current second single bet pricing for the second activity for the event; and
wherein the front-end server determines on a real-time basis and based on the betting data received, on a real-time basis, from the back-end server, an updated betting option for the SGP bet;
wherein the front-end server communicate, on a real-time basis, the updated betting option for the SGP bet to the SGP application instantiated on the user device;
wherein the SGP application presents the updated betting option for the SGP bet as an updated SGP bet to the user in order to facilitate real-time selection by the user of the updated SGP bet during the event.

12. The aligned single game parlay system of claim 11,
wherein the SGP bet includes a combination, identified by the user, of two or more betting activity options for the event.

13. A process for aligning pricing, by a server, for a first Single Game Parlay (“SGP”) betting line with a single bet line, for a first activity for an event, by the server performing counter tilting operations comprising:
receiving an initial SGP pricing for the first SGP betting line;
wherein the initial SGP pricing is determined based on an initial set of counters;
receiving an initial single bet pricing for the single bet line;
determining if the initial single bet pricing and the initial SGP pricing are aligned;
when aligned,
using the initial SGP pricing for the first SGP betting line; and
when not aligned,
adjusting the initial set of counters to provide an adjusted set of counters; and
iteratively generating, based on the adjusted set of counters, one or more instances of an adjusted first SGP pricing until the adjusted first SGP pricing aligns with a current single bet pricing for the single bet line.

14. The process of claim 13,
wherein the counter tilting operations further comprise:
adjusting the initial set of counters to provide the adjusted set of counters by further performing at least one of counter duplication operations and counter deletion operations;
wherein the counter duplication operations include:
duplicating at least one counter selected from the initial set of counters to provide a duplicated counter; and
adding the duplicated counter to the initial set of counters to provide, as the adjusted set of counters, the initial set of counters plus the duplicated counter; and
wherein counter deletion operations include:
deleting at least one counter from the initial set of counter to provide, as the adjusted set of counters, the initial set of counters less the duplicated counter.

15. The process of claim 13,
wherein the counter tilting operations further comprise:
generating, based on the adjusted set of counters, adjusted simulations for the first activity;
determining, based on the adjusted simulations, an adjusted first probability of a future result occurring for the first SGP betting line;
determining, based on the adjusted simulations, an adjusted second probability of the future result not occurring for the first SGP betting line;
associating an adjusted first pricing with the adjusted first probability;
associating an adjusted second pricing with the adjusted second probability; and
generating the adjusted first SGP betting line based on the adjusted first pricing and the adjusted second pricing.

16. The process of claim 15,
wherein the counter tilting operations further comprise:
determining whether the adjusted first SGP betting line aligns with the current single bet pricing; and
when not aligned, iteratively repeating the counter tilting operations until a currently adjusted first SGP pricing is aligned and the current single bet pricing.

17. A computer readable medium storing non-transient computer instructions which when executed by a processor in a server instruct the server to perform counter tilting operations comprising:
receiving an initial Single Game Parlay (“SGP”) pricing for a first SGP betting line for a first activity for an event;
wherein the initial SGP pricing is determined based on an initial set of counters;
receiving an initial single game pricing for a single game betting line for the given activity for the event;
determining if the initial single bet pricing and the initial SGP pricing are aligned;
when aligned,
using the initial SGP pricing for the first SGP betting line; and
when not aligned,
adjusting the initial set of counters to provide an adjusted set of counters; and
iteratively generating, based on the adjusted set of counters, one or more instances of an adjusted first SGP pricing until the adjusted first SGP pricing aligns with a current single bet pricing for the single bet line.

18. The computer readable medium of claim 17,
wherein the counter tilting operations further comprise:
adjusting the initial set of counters to provide the adjusted set of counters by further performing at least one of counter duplication operations and counter deletion operations;
wherein the counter duplication operations include:
duplicating at least one counter selected from the initial set of counters to provide a duplicated counter; and
adding the duplicated counter to the initial set of counters to provide, as the adjusted set of counters, the initial set of counters plus the duplicated counter; and
wherein counter deletion operations include:
deleting at least one counter from the initial set of counter to provide, as the adjusted set of counters, the initial set of counters less the duplicated counter.

19. The computer readable medium of claim 18,
wherein the counter tilting operations further comprise:
generating, based on the adjusted set of counters, adjusted simulations for the first activity;
determining, based on the adjusted simulations, an adjusted first probability of a future result occurring for the first SGP betting line;
determining, based on the adjusted simulations, an adjusted second probability of the future result not occurring for the first SGP betting line;
associating an adjusted first pricing with the adjusted first probability;
associating an adjusted second pricing with the adjusted second probability; and
generating the adjusted first SGP betting line based on the adjusted first pricing and the adjusted second pricing.

20. The computer readable medium of claim 19,
wherein the counter-tilting operations further comprise:
determining whether the adjusted first SGP betting line aligns with the current single bet pricing; and
when not aligned, iteratively repeating the counter-tilting operations until a currently adjusted first SGP pricing is aligned and the current single bet pricing.
